(19) United States
(12) Patent Application Publication
(10) Pub. No.: US 2020/0099575 A1
(43) Pub. Date: Mar. 26, 2020

(54) DEVICE AND METHOD FOR FAILOVER

(71) Applicant: Institute For Information Industry, Taipei (TW)

(72) Inventor: Kai-Yuan JAN, Taipei City (TW)

(21) Appl. No.: 16/172,538

(22) Filed: Oct. 26, 2018

(30) Foreign Application Priority Data
Sep. 20, 2018 (TW) 107133183

(51) Int. Cl. H04L 12/24; H04L 29/08; H04L 9/32; G06F 17/30

(52) U.S. Cl. CPC H04L 41/0663; H04L 41/0668; H04L 41/0266; H04L 41/145; G06F 17/30997; H04L 67/12; H04L 9/3239; G06F 17/30958; H04L 41/12

(57) ABSTRACT

A device and method for failover are disclosed. The device receives a network topology data and a plurality of device metadata of an IoT system and converts them to a management topology data and a plurality of management metadata. After receiving a failure message related to a first apparatus of the IoT system, the device simulates a plurality of device connection relationships between the devices of the IoT system, calculates a plurality of failover costs according to the device connection relationships, chooses a second apparatus to be a failover target according to the failover costs, finds out at least one correctly verified management metadata according to a plurality of hash data and a hash function, converts the at least one verified management metadata into a format complying to the device metadata of the IoT system, delivers the converted management metadata to the second apparatus, and updates the management topology data.

### PRIORITY

This application claims priority to Taiwan Patent Application No. 107133183 filed on Sep. 20, 2018, which is hereby incorporated by reference in its entirety.

### FIELD

The present invention relates to a system and a method for failover. More particularly, the present invention relates to a system and a method for failover related to the Internet of Things (IoT) system.

### BACKGROUND

With the development of technology, computer devices are becoming more and more complex, and many factors may make computer devices unable to operate normally, such as: malfunction of electronic components, crash or external force intervention.

Although many computer devices and systems have failover mechanisms to maintain the assigned functions or services, with the increasing use of the IoT, the existing failover mechanism technology may not coordinate efficiently with the IoT system. For example, some existing technologies additionally configure a device with equivalent specification as a backup device for an important primary device. The preset state of the backup device is a standby state, and the backup device only periodically receives backup data transmitted from the primary device and monitor whether operations of the primary device are performed normally. When the backup device detects that the primary device is error or malfunctioned and cannot be normally operated, the backup device performs a recovery procedure according to the last backup data transmitted from the primary device, and switches from the standby state to a startup state to replace the role played by the primary device to maintain the functionality or service that the primary device was originally assigned.

The architecture of the IoT, however, is more complex than traditional networks. Many IoT devices play an important role to make the IoT system exert good extensibility and flexibility. If existing technologies are used to improve the fault tolerance of the IoT system, the configuration cost will increase with the expansion of the IoT system, so the configuration of the IoT system may not be adjust easily, and therefore the extensibility of the IoT system may not be exerted effectively. Moreover, once the backup device is abnormal, the important device may lose the failover mechanism, which leads to the flexibility of the IoT system may not be exerted effectively.

In view of this, how to improve the fault tolerance of the IoT system and fully utilize the flexibility and extensibility of the IoT system is a problem that needs to be solved.

### SUMMARY

Provided herein is a device for failover. The device for failover can comprise a network interface, a processor, and a storage, wherein the processor is connected to the network interface and the storage. The network interface is connected to an Internet of Things (IoT) system, and configured to receive a network topology data and a plurality of device metadata of the IoT system, wherein each of the plurality of device metadata comprises a plurality of backup data and a plurality of hash data. The processor is configured to convert the network topology data to a management topology data and convert each of the plurality of device metadata to a management metadata. The storage is configured to store the management topology data and the plurality of management metadata.

The network interface receives a failure message related to a first device of the IoT system. The processor simulates a plurality of connection relationships between devices according to the failure message, calculates a plurality of failover costs according to the plurality of connection relationships between devices, and chooses a second device from the IoT system according to the plurality of failover costs. The processor finds out the plurality of hash data corresponding to the first device according to the at least one management metadata corresponding to the first device, and finds out at least one correctly verified backup data by a hash function and the found plurality of hash data. The network interface transmits the at least one correctly verified backup data to the second device. The processor updates the management topology data according to the at least one connection relationships between devices corresponding to the second device.

Also provided is a method for failover, which is suitable for an electronic computing device of an IoT system. The method for failover can comprise the following step (a) to step (l).

The step (a) receives a network topology data and a plurality of device metadata of the IoT system, wherein each of the plurality of device metadata comprises a plurality of backup data and a plurality of hash data. The step (b) converts the network topology data to a management topology data. The step (c) converts each of the plurality of device metadata to a management metadata. The step (d) stores the management topology data and the plurality of management metadata. The step (e) receives a failure message related to a first device of the IoT system. The step (f) simulates a plurality of device connection relationships between devices according to the failure message. The step (g) calculates a plurality of failover costs according to the plurality of device connection relationships. The step (h) chooses a second device from the IoT system according to the plurality of failover costs. The step (i) finds out the plurality of hash data corresponding to the first device according to the at least one management metadata corresponding to the first device. The step (j) finds out at least one correctly verified backup data by a hash function and the found plurality of hash data. The step (k) transmits the at least one correctly verified backup data to the second device. The step (l) updates the management topology data according to the at least one device connection relationships corresponding to the second device.

The device and method for failover utilize a real-time device connection relationship to select a suitable handover device to perform failover applicable to the IoT system. Specifically, the device and method for failover of the present invention calculate a plurality of failover costs according to a real-time device connection relationship of the IoT system when a first device of the IoT system is unable to operate normally, select a second device which has a better failover cost from IoT devices with normal operation as a handover device for the first device, verify the integrity of backup data according to hash function and hash data, and transmit the verified backup data to the second device to replace the first device which is unable to operate normally by the second device. Thereby, the function or service originally assigned for the first device is continuously provided by the second device.

The device and method for failover may select an IoT device with a better failover cost from IoT devices with normal operation as an object for failover, to develop a failover mechanism on the fly during execution, and eliminate the cost of configuring dedicated backup devices, and exert the good extensibility of the IoT system by developing a failover mechanism on the fly. In addition, since the device and method for failover provided by the present invention are applicable to an IoT system, a plurality of possible transmission paths may be considered when selecting a failover object to fully exert the good flexibility of the IoT system. Furthermore, the device and method for failover provided by the present invention may adjust the calculation method of the failover cost according to different considerations (e.g., according to factors such as energy consumption, delay time, and/or connection stability of the IoT device), which increases the flexibility of use.

The detailed technologies and embodiments of the present invention are described in the following description in conjunction with the drawings, and the technical features of the claimed invention may be understood by a person having ordinary skill in the art.

### BRIEF DESCRIPTION OF THE DRAWINGS

FIG. 1 is a structural diagram of a device for failover connected to an IoT system according to the first embodiment of the present invention.

FIG. 2 is a flow chart of sequence hashing process of the present invention.

FIG. 3 is a specific example of the managing metadata illustrated in FIG. 1.

FIG. 4 is a flow chart of the method for failover according to the second embodiment of the present invention.

### DETAILED DESCRIPTION

In the following description, explanation for the system and the method for monitoring qualities of teaching and learning will be provided according to certain example embodiments. However, the example embodiments described hereinafter are not intended to limit the present invention to any specific example, embodiment, environments, applications, or specific process flows or steps described in these example embodiments. The scope of the present invention should be determined according to the Claims.

It should be understood that, in the following embodiments and the drawings, the components that are not directly related to the present invention are omitted and are not shown, and the dimensions of the components and the ratios of the dimensions between the components are merely illustrative and are not intended to limit the scope of the present invention.

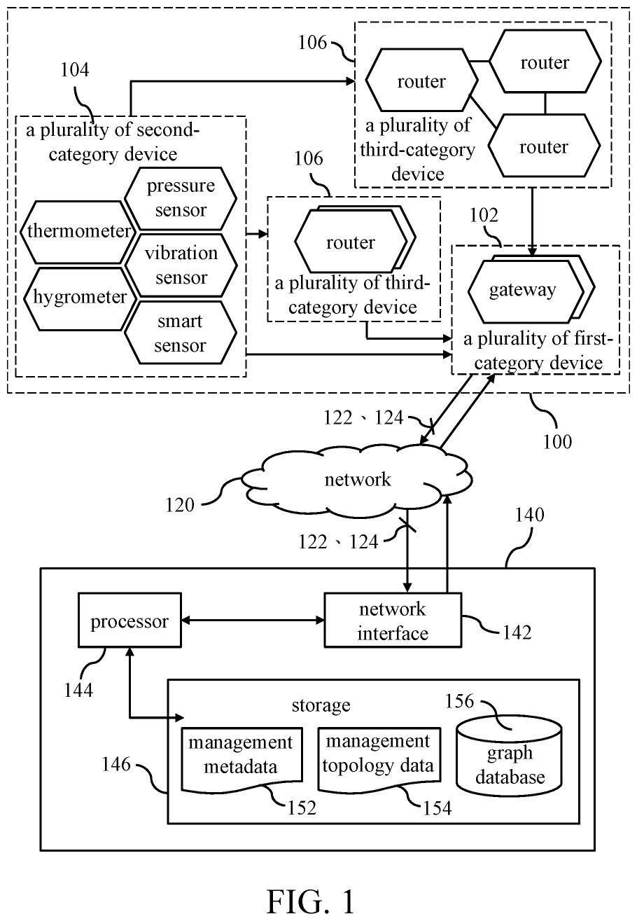

FIG. 1 is a structural diagram of the device for failover 140 of the first embodiment of the present invention and the IoT system 100 to which it is applied. The architecture and operation of the IoT system 100 will be described first, and the architecture and operation of the device for failover 140 will then be described.

The IoT system 100 may be connected to a network 120 through a wired access or wireless access connection, and connected to the device for failover 140 via the network 120. The network 120 may be a private network (e.g., a regional network) or a public network (e.g., the Internet). The IoT system 100 comprises a plurality of first-category devices 102, a plurality of second-category devices 104, and a plurality of third-category devices 106, wherein the plurality of first-category devices 102, the plurality of second-category devices 104, and the plurality of third-category device 106 may form a private network of a mesh network architecture through a wired access or wireless access connection. In FIG. 1, each hexagon represents a first-category device, a second-category device, or a third-category device, and the number of hexagons is not intended to limit the scope of the invention.

In the present embodiment, the IoT system 100 has been deployed and configured, and thus the network topology formed by the plurality of first-category devices 102, the plurality of second-category devices 104, and the plurality of third-category devices 106 are determined. It should be noted that, in this embodiment, the connection settings between the first-category device 102, the second-category device 104, and the third-category device 106 may be different due to different actual distances between the devices. The preset setting of some second-category devices 104 is to directly communicate and exchange data with the corresponding first-category device 102, and the preset settings of some second-category devices 104 is to indirectly communicate and exchange data with the corresponding first-category of devices 102 through the forward by one or more corresponding third-category devices 106.

It should be noted that, in this embodiment, the first-category device 102 corresponding to a second-category device 104 may be referred to as the designated first-category device 102 of the second-category device 104. Similarly, the third-category device 106 corresponding to a second-category device 104 may be referred to as the designated third-category device 106 of the second-category device 104, and the first-category device 102 corresponding to a third-category device 106 may be referred to as the designated first-category device 102 of the third-category device 106, and so on, and it will not be enumerated here. It should be additionally noted that the above-mentioned “directly communicate and exchange data” means that the communication and data exchange between the devices are not transmitted through other devices, and the above “indirectly communicate and exchange data” means that communication and data exchange between devices is carried out through other devices.

In this embodiment, each of the plurality of second-category devices 104 may be a sensor, such as a thermometer, a hygrometer, a pressure sensor, a vibration sensor, a light sensor, an image sensor, or a smart sensor consisting of a plurality of sensors as described above, but not limited thereto. Each of the second-category devices 104 periodically measures different environmental messages, adds a measured measurement message to a time tag, and then periodically transmits the measurement message to the designated first-category device 102, or periodically transmits the measurement message to the designated first-category device 102 via the at least one of the third-category devices 106. In some embodiments, each of the second-category devices 104 periodically transmits the measurement message and a device message of the second-category device 104 itself to the designated first-category device 102, or periodically transmits the measurement message and a device message of the second-category device 104 itself to the designated first-category device 102 via the at least one of the third-category device 106.

Each of the first-category devices 102 may be a gateway for receiving and collecting the measurement message transmitted by a corresponding second-category device 104 (i.e., the second-category devices 104 which it directly or indirectly communicates with in a preset working setting), and for receiving the respective device messages of the corresponding second-category device 104 and the corresponding third-category device 106 (i.e., the third-category device 106 which it directly or indirectly communicates with in a preset working setting). It should be noted that each of the first-category devices 102 may also extract device information of the internal device. In some embodiments, some of the first-category devices 102 may perform a screening process (not shown in figures) or a computing process (not shown in figures) of the measurement message and the device information to generate processing data (not shown in figures). The screening process may delete error or abnormal measurement information according to a threshold or a data table, and the calculation process may convert the measurement information transmitted by the corresponding second-category device 104 into another value or another format corresponding to a numerical operation or a format conversion.

Each of the third-category devices 106 may be a router, a hub, a switch, or an access point for transmitting the measurement message and the device message sent by the corresponding second-category device 104 (i.e., the second-category device 104 which it directly or indirectly communicates with in a preset working setting) to the designated first-category type device 102, or for transmitting the measurement message and the device information sent by the corresponding second-category device 104 to the designated first-category device 102 through the at least one third-category device 106. By deploying the plurality of third-category devices 106 in the IoT system 100, when a certain second-category device 104 is unable to directly exchange data with the first-category device 102, the second-category device 104 may indirectly exchange data with the first-category device 102 via the at least one third-category device 106. In addition, each of the third-category devices 106 may also directly transmit its own device information to the designated first-category device 102, or indirectly transmit its own device information to the designated first-category device 102 via other third-category device 106.

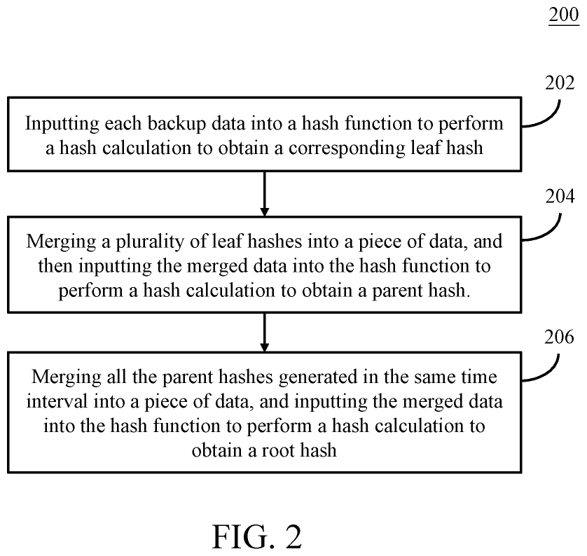

Each of the first-category devices 102 may designate a plurality of important data as a plurality of backup data, and perform a sequence hashing process 200 for the plurality of backup data (as shown in FIG. 2) to generate a plurality of hash data. In this embodiment, the important data of a first-category device 102 may be a corresponding measurement message (i.e., the measurement message received directly or indirectly), corresponding processing data (i.e., the processing data generated by itself), or/and corresponding device messages (i.e., the device messages received directly or indirectly or/and their own device messages). Then, each of the first-category devices 102 integrates the plurality of backup data and the plurality of hash data into a device metadata 122 (e.g., storing the plurality of backup data and the plurality of hash data in the same file), and transmits the device metadata 122 to the device for failover 140 through the network 120, thereby achieving backup of important data for each of the first-category devices 102 in the IoT system 100. Each of the first-category devices 102 periodically performs the foregoing operations on the updated important data (i.e., periodically designates the updated important data as backup data, performs sequence hashing process 200, integrates them into device metadata 122, and then transmits them to the device for failover 140). In this embodiment, each backup data may comprise one or more important data.

In this embodiment, the device information may comprise an identification message, a system setting, a CPU usage rate, a memory usage rate, an Internet Protocol address (IP Address), and a communication port, a device energy consumption, and/or a connection lifetime, but not limited to them. The identification message may comprise, but is not limited to, a Globally Unique Identifier (GUID) or/and a device custom name, etc., which may be used to identify the identity of the device. The system settings may include a backup process, a screening process, a calculation process, a sequence hashing process, and a processing cycle of the foregoing processes.

The Internet Protocol address comprises its own Internet Protocol address in the IoT system 100, the Internet Protocol Address of the corresponding second-category device 104 and the third-category device 106, and the Internet Protocol Address of the device for failover 140, etc. The connection lifetime is the total network connection time or the average network connection time between any two of the plurality of first-category devices 102, the plurality of second-category devices 104, and the plurality of third-category devices 106. For example, the connection lifetime may be the total network connection time or the average network connection time between each of the second-category devices 104 and its first-category device 102.

Similarly, the connection lifetime may be the total network connection time or the average network connection time between each of the second-category device 104 and its designated third-category device 106, the total network connection time or the average network connection time between each of the third-category device 106 and its designated third-category device 106, and the total network connection time or the average network connection time between each of the third-category devices 106 and its designated first-category device 102.

Next, please refer to FIG. 2, which is a flow chart of the sequence hashing process 200 of the present invention. The present invention defines a plurality of time intervals (e.g., each day as a time interval, each week as a time interval, or each month as a time interval), and each of the first-category devices 102 performs the sequence hashing process 200 to backup important data of different time periods periodically within each time interval. The sequence hashing process 200 comprises steps 202 to 206 as detailed below.

Step 202: Inputting each backup data into a hash function to perform a hash calculation to obtain a corresponding leaf hash. Each backup data will generate a corresponding leaf hash. The hash function is one of a Secure Hash Algorithm 1 (SHA-1) and an MD5 Message-Digest Algorithm, but is not limited thereto.

Step 204: merging a plurality of leaf hashes into a piece of data (e.g., concatenating the plurality of leaf hashes, adding the plurality of leaf hashes), and then inputting the merged data into the hash function to perform a hash calculation to obtain a parent hash.

Step 206: merging all the parent hashes generated in the same time interval into a piece of data (e.g., concatenating all parent hashes generated in a time interval, arithmetic addition of all parent hashes generated in a time interval), and inputting the merged data into the hash function to perform a hash calculation to obtain a root hash.

In the present embodiment, after performing step 202, step 204, and step 206 for a time period in a time interval, each of the first-category devices 102 transmits a device metadata 122 of the time period to the device for failover 140, wherein the device metadata 122 comprises backup data, leaf hash, parent hash, and root hash of the time period. In some embodiments, each of the first-category devices 102 transmits the device metadata 122 of the time interval to the device for failover 140 after the sequence hashing process 200 for a time interval is completed, wherein the device metadata 122 comprises backup data, leaf hash, parent hash, and root hash of different time periods within the time interval.

For ease of understanding, a specific example is described, but it is not intended to limit the scope of the invention. In this specific example, the time interval described in step 206 is distinguished according to the date, that is, the same date belongs to the same time interval, and different dates are different time intervals. In this specific example, the first-category device 102 performs a sequence hashing process 200 on a plurality of backup data at one or more fixed time points each day, for example, each of the first-category devices 102 periodically performs sequence hashing process 200 on a plurality of backup data between 00:00 and 07:59 of each day, periodically performs sequence hashing process 200 on a plurality of backup data between 08:00 and 15:59 of each day, and periodically performs sequence hashing process 200 on a plurality of backup data between 16:00 and 23:59 of each day. In the specific example, each of the first-category devices 102 stores the backup data, leaf hash, parent hash, and root hash of each time period as a device metadata 122, and transmits the device metadata 122 to the device for failover 140. In some embodiments, each of the first-category devices 102 stores backup data, leaf hashes, parent hashes, and root hashes at different time points in the same time interval as a device metadata 122, and then transmits the device metadata 122 to the device for failover 140.

Since each of the first-category devices 102 transmits one or more device metadata 122 to the device for failover 140 for different time intervals (e.g., for each day), the device for failover 140 receives a plurality of device metadata 122.

In addition, in the embodiment, the IoT system 100 further comprises a network management module (not shown in figures). The network management module may be a general network management program, and may be installed in any independent electronic computing device connected to the area network formed by the IoT system 100. The network management module may instantly collect and monitor a plurality of network connection relationships of all the second-category devices 104, the first-category devices 102, and the third-category devices 106 in the IoT system 100. Therefore, after the IoT system 100 is deployed and set, the network management module knows the network topology formed by the plurality of first-category devices 102, the plurality of second-category devices 104, and the plurality of third-category devices 106. The network management module generates a network topology data 124 according to the network topology, and transmits the network topology data 124 to the device for failover 140 through the network 120.

Please refer to FIG. 1, the device for failover 140 of the present embodiment comprises a network interface 142, a processor 144, and a storage 146. The processor 144 is electrically connected to the network interface 142 and the storage 146. In this embodiment, the device for failover 140 may be various types of electronic computing devices, such as but not limited to, a server, a notebook computer, a tablet computer, a desktop computer, and the like. The network interface 142 may be a physical network interface card provided in a general electronic computing device/computer as an interconnection point between the device for failover 140 and the network 120. According to different requirements, the network interface 142 allows the device for failover 140 to communicate with and exchange data with the first-category device 102 through the network 120 in a wired or wireless access manner. The processor 144 may be any of a variety of processors, central processing units (CPUs), microprocessors, or other computing devices known to a person having ordinary skill in the art. The storage 146 may be a memory, a universal serial bus (USB) disk, a hard disk, a compact disk (CD), a flash drive, a database, or any other storage medium or storage circuit having the same function known by a person having ordinary skill in the art.

As shown in FIG. 1, the network interface 142 is connected to the IoT system 100, and receives the plurality of device metadata 122 and the network topology data 124 transmitted by the IoT system 100, wherein each device metadata 122 comprises a plurality of backup data and a plurality of hash data. In the present embodiment, the processor 144 converts the plurality of device metadata 122 in the same time interval into a management metadata 152, and converts the network topology data 124 into management topology data 154. For example, each of the management metadata 152 and the management topology data 154 may manage the data contained therein in a graph format. The storage 146 stores the management metadata 152 and the management topology data 154.

When the network management module of the IoT system 100 detects that a first device in the plurality of first-category devices 102 is unable to operate normally or fails, the network management module transmits a failure message (not shown) related to the failure of the first device to the device or failover 140. In this embodiment, the network management module may determine whether the plurality of first-category devices 102 are operating normally by receiving heartbeat signals. Thereby, when the first device in the plurality of first-category devices 102 fails, the network management module may immediately send a failure message. It should be noted that the network management module may use other technologies to determine whether each of the first-category devices 102 is in normal operations, which is not limited by the present invention.

After the network interface 142 of the device for failover 140 receives the failure message about the first device transmitted by the IoT system 100, the processor 144 simulates a plurality of device connection relationships according to the failure message. Specifically, the processor 144 may first remove the connection channel/connection relationship directly associated with the first device in the management topology data 154 according to the failure message, and then simulate a plurality of device connection relationships that can make all of the associated devices that have work association with the first device (i.e., the second-category devices that originally communicates with and exchanges data with the first device directly or indirectly) still be connected to a certain (or some) first-category device(s) after the first device fails. Each of the foregoing device connection relationships is a direct connection relationship between a device and a device (i.e., they perform direct communication and data exchange).

Next, the processor 144 calculates a plurality of failover costs based on the device connection relationships. In this embodiment, the processor 144 finds out at least one candidate device which may replace the first device from the plurality of second-category devices 102 according to the management topology data 154 and the device connection relationships, and finds out all associated devices that have working relationships with the first device according to the management topology data 154.

Then, the processor 144 finds out signal transmission paths connected to each of the candidate devices for each associated device according to a selection strategy, and calculates costs of each signal transmission path according to a cost formula corresponding to the selection strategy. The selection strategy may be the lowest energy consumption, the minimum communication delay, or/and the longest connection lifetime. Therefore, the cost formula may be to accumulate all energy consumption on a signal transmission path from an associated device to a candidate device, and accumulate all communication delays on a signal transmission path from an associated device to a candidate device, or/and all connection lifetime on a signal transmission path from an associated device to a candidate device. In this embodiment, different selection strategies (i.e., using different cost formulas) for evaluation will result in a corresponding failover cost, so each failover cost may be related to one of or a combination of: an energy consumption, a communication delay, and a connection lifetime.

Next, the processor 144 selects a second device from the at least one candidate device to replace the first device according to the failover cost. Specifically, the processor 144 may calculate, according to the plurality of failover costs, a plurality of total costs of changing the associated devices to connect (directly or indirectly) to each of the at least one candidate device, and then select the candidate device corresponding to the lowest total cost as the second device to replace the first device. Then, the signal transmission path corresponding to the second device will be the replacing signal transmission path of the associated devices having work association with the first device (i.e., the second-category devices which originally communicates with and exchanges data with the first device directly or indirectly).

After selecting the second device, the device for failover 140 needs to provide the backup data of the first device to the second device to enable operations. Specifically, the processor 144 finds out the hash data corresponding to the first device according to the at least one management metadata 152 corresponding to the first device, and finds out at least one backup data verified to be correct by using a hash function and the found hash data. In this embodiment, the hash function is one of a Secure Hash Algorithm 1 (SHA-1) and an MD5 Message-Digest Algorithm, but is not limited thereto. It should be noted that the hash function used by the processor 144 needs to be the same as the hash function used by the first device. Since the packet of the data transmitted/received through the network 120 may be lost due to various factors and result in an error in the content of the packet, it is necessary to verify the integrity of the backup data before transmitting the backup data to the second device.

As described before, the plurality of device metadata transmitted by the first-category device 102 to the device for failover 140 through the network 120 in a time interval (e.g., one day, one week, or one month) may be converted to a management data 152 by the processor 144, wherein each management metadata 152 in different time periods in a time interval comprises a plurality of backup data and a plurality of hash data, and wherein each backup data in each time period has a corresponding leaf hash, the plurality of leaf hashes correspond to a parent hash, and one or more parent hashes correspond to a root hash. Therefore, when the processor 144 selects a certain management metadata 152 of the first device, the processor 144 may verify the integrity of the backup data according to the hash function, the corresponding leaf hash, the associated parent hash, and the associated root hash.

It should be noted that the processor 144 may select the management metadata 152 of the closest time period or select the management metadata 152 according to the time interval in which the first device fails (e.g., the same day), and then selects the root hash, parent hash, leaf hash, and backup data to be verified as described according to the specific time of the failure of the first device. If the selected backup data fails the verification, the processor 144 may verify the root hash, the parent hash, the leaf hash, and the backup data of the management metadata 152 in other time periods of the same time interval, and search for the verified backup data, or the processor 144 may find the correct backup data in the management metadata in different time intervals (e.g., different dates).

For ease of explanation, a specific example is described, but it is not intended to limit the scope of the invention. In this specific example, a first-category device 102 is backed up three times a day, that is, to backup the important data in each time period (e.g., 00:00 to 07:59, 08:00-15:59, and 16:00-23:59) at the three time points of 7:59, 15:59, and 23:59 to obtain device metadata 122 in these periods. If the failure occurs at 19:20 on Jul. 18, 2018, the processor 144 first selects the management metadata 152 on the day the failure occurs, and verifies whether the root hash of the second time period (08:00-15:59) in the same day (Jul. 18, 2018)) is the hash value which is obtained by calculating the combined data of the parent hash of the first time period (00:00-07:59) and the parent hash of the second time period of the same day through the hash function. If the root hash of the second period is equal to the hash value generated by calculating the combined data of the parent hash of the first time period and the parent hash of the second time period of the same day through the hash function, it represents that the parent hash of the first period and the parent hash of the second time period is still correct after being transferred to the device for failover 140.

Since the verification of the root hash is correct, the processor 144 then verifies whether the parent hash of the second time period is the hash value obtained by calculating the combined data of the plurality of leaf hashes of the second time period through the hash function. If the parent hash of the second time period is equal to the hash value generated by calculating the combined data of the plurality of leaf hashes of the second time period through the hash function, it represents that the leaf hashes of the second time period are still correct after being transmitted to the device for failover 140. Since the parent hash is verified to be correct, the processor 144 then verifies whether each leaf hash is the hash value obtained by calculating the corresponding backup data through the hash function. If the verification results in each leaf hash being the hash value obtained by calculating the corresponding backup data through the hash function, it represents that each backup data of the time period is still correct after being transmitted to the device for failover 140. Conversely, if the verification results in a certain leaf hash not matching the hash value generated from corresponding backup data, it represents that the corresponding backup data is incorrect, and it is necessary to search again from other time intervals.

In addition, if the root hash of the second period is verified not being equivalent to the hash value generated by calculating the combined data of the parent hash of the first time period and the parent hash of the second time period through the hash function, it represents that an error occurred in at least one of the parent hash of the first time period, a parent hash of the second time period, and a root hash of the second time period stored by the device for failover 140 due to certain factors (e.g., losing packets in the process of transmitting to the device for failover 140).

Since the root hash has not passed the verification, the processor 144 then selects the management metadata 152 in a different day (e.g., the previous day, Jul. 17, 2018) to verify whether the root hash of the third time period (16:00-23:59) of the day (Jul. 17, 2018) is the value obtained by calculating the combined value of the parent hash of the first period (00:00-07:59), the parent hash of the second period, and the parent hash of the third period of the day (Jul. 17, 2018) through the hash function. The processor 144 may continue repeating the foregoing verification process until all required backup data is found, and details are not described herein. The described hash structure and verification method are used to improve the verification efficiency and flexibility of the backup data.

After the backup data is verified to be correct, the network interface 142 transmits the at least one backup data that is verified to be correct to the second device. The second device performs a recovery procedure to obtain a system setting of the first device from the at least one backup data which is verified to be correct, and adds the system setting of the first device to the second device, so that the second device takes over and continues providing the services and functions originally provided by the first device. In addition, the processor 144 updates the management topology data 154 according to the at least one device connection relationships corresponding to the second device. In this embodiment, the device connection relationship(s) corresponding to the second device is (are) the device connection relationship(s) comprised in the succeeding signal transmission path(s).

Through the foregoing operation, the device for failover 140 completes the failover operation when the first device fails.

In some embodiments, the storage 146 stores a graph database 156, and the processor 144 may execute a graphical program (not shown) to converted the management metadata 152 and management topology data 154 to a format that conforms to the graph database 156 (e.g., via a graphical structured language (Graph-SQL)). For example, if the graph database 156 is a graph database named neo4j, the device metadata may be converted into the management metadata 152 conforming to the neo4j graph database format by executing the Cypher query language, and the network topology data is converted into a management topology data 154 conforming to the neo4j graph database format.

In these embodiments, each of the management metadata 152 and the management topology data 154 obtained via the graphical program comprises a plurality of node data, a plurality of edge data, a plurality of node property data, and a plurality of edge property data.

Specifically, the plurality of node data in the management topology data 154 correspond to the plurality of first-category device nodes, the plurality of second-category device nodes, and the plurality of third-category device nodes. The plurality of edge data in the management topology data 154 comprises at least one first edge which restricts unidirectional transmission of messages from the second-category device 104 to the third-category device 106, at least one second edge which allows bidirectional transmission of messages between the third-category device 106 and the third-category device 106, at least one third edge which restricts unidirectional transmission of messages from the third-category device 106 to the first-category device 102, and at least one fourth edge which restricts unidirectional transmission of messages from the second-category device 104 to the first-category device 102, but not limited thereto. The plurality of node property data in the management topology data 154 comprises, but not limited to, identification information of the corresponding node, power consumption, and whether it is allowed as an object for failover. The plurality of edge property data in each of the management topology data 154 comprises, but not limited to, identification information of the corresponding edge line and connection lifetime.

In addition, each of the management metadata 152 may be a hash tree after being graphically represented, and each of the hash trees comprises a node, a plurality of parent nodes, and a plurality of leaf nodes. The plurality of node data in each of the management metadata 152 correspond to the leaf node, the plurality of parent nodes, and the plurality of root nodes. The plurality of edge data in each of the management metadata 152 comprises a plurality of fifth edges connected by the leaf node and the parent node, and a plurality of sixth edges connected by the parent node and the root node, but not limited thereto. The plurality of edge property data in each of the management metadata 152 comprises, but not limited to, identification information and hash function of the corresponding edge.

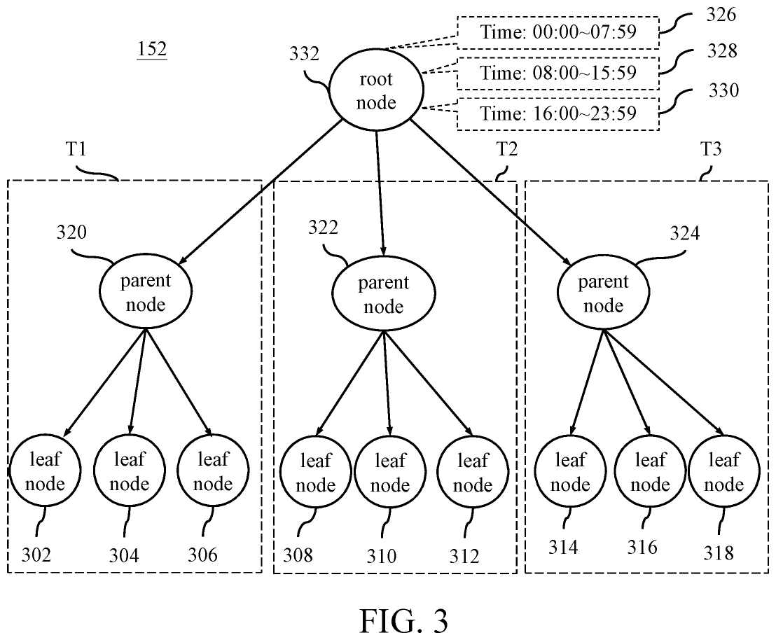

Please refer to FIG. 3, which is a specific example of the graphical management metadata 152. The specific examples shown in FIG. 3 are for illustrative purposes only and are not intended to limit the scope of the invention. In this specific example, a first-category device 102 is backed up three times a day, that is, to backup the important data in each time period (e.g., 00:00 to 07:59, 08:00-15:59, and 16:00-23:59) at the three time points of 7:59, 15:59, and 23:59 to obtain device metadata 122 in these periods. The root hash, parent hash, and leaf hash of the device metadata 122 are verified in a similar manner to the specific examples described above, and are not described herein again.

As shown in FIG. 3, after being transmitted to the device for failover 140, the device metadata 122 of the first-category device 102 in the first time period T1 (00:00-07:59) is converted, by the processor 144, to the first part 326 in the root node 332, the parent node 320, the leaf node 302, the leaf node 304, and the leaf node 306, wherein each of the leaf nodes 302, 304, and 306 comprises a backup data and a corresponding leaf hash generated by calculating through the hash function, the parent node comprises the parent hash which is generated by calculating the combined data of each leaf hash of the first time period T1 through the hash function, and the first part 326 of the root node 332 comprises the root hash which is generated by calculating the parent hash of the first time period T1 through the hash function.

Similarly, the device metadata 122 of the first-category device 102 in the second time period T2 (08:00-15:59) is converted, by the processor 144, to the second part 328 in the root node 332, the parent node 322, the leaf node 308, the leaf node 310, and the leaf node 312, wherein each of the leaf nodes 308, 310, 312 comprises a backup data and a corresponding leaf hash generated by calculating through the hash function, the parent node 322 comprises the parent hash which is generated by calculating the combined data of each leaf hash of the second time period T2 through the hash function, and the second part 328 of the root node 332 comprises the root hash which is generated by calculating the combined data of the parent hash of the first time period T1 and the parent hash of the second time period T2 through the hash function.

The device metadata 122 of the first-category device 102 in the third time period T3 (16:00-23:59) is converted, by the processor 144, to the third part 330 in the root node 332, the parent node 324, the leaf node 314, the leaf node 316 and the leaf node 318, wherein each of the leaf nodes 314, 316, 318 comprises a backup data and a corresponding leaf hash generated by calculating through the hash function, the parent node 324 comprises the parent hash which is generated by calculating the combined data of each leaf hash of the third time period T3 through the hash function, and the third part 330 in the root node 332 comprises the root hash which is generated by calculating the combined data of the parent hash of the first time period T1, the parent hash of the second time period T2, and the parent hash of the third time period T3 through the hash function.

In some embodiments, the processor 144 simulates the aforesaid device connection relationships by querying the related data in the graph database 156. Specifically, the processor 144 finds out the node data, at least one edge data, and the plurality of edge property data of the management topology data 154 which are corresponding to the failure message, and removes at least one edge data and the edge property data corresponding to the failure message (e.g., noticing the first device fails according to the failure message, the processor 144 removes all edges and their edge properties associated with the first device), and then simulates the device connection relationships.

In some embodiments, the processor 144 calculates the failover costs by querying related data in the graph database 156. Specifically, the processor 144 obtains, according to the management topology data 154, at least one first-category node which is associated with the first device, and obtains, according to the management topology data 154, at least one second-category that may be used as an object for failover. Each of the described first-category nodes corresponds to one of the plurality of second-category device nodes, and each of the at least one second-category nodes corresponds to one of the plurality of first-category device nodes. The at least one second-category node corresponds to the described at least one candidate device.

Next, the processor 144 calculates an evaluation cost of transmitting from each of the at least one first-category nodes to each of the at least one second-category nodes as the plurality of failover costs according to the plurality of edge data and the plurality of edge property data of the management topology data 154. Using the node data, the edge data, the energy consumption comprised in the node data, the signal transmission direction restrictions comprised in the edge data, and the connection lifetime comprised in the edge properties provided by the graph database 156, the processor 144 may speed up the operation of calculating the evaluation cost of transmitting from each of the at least one first-category nodes to each of the at least one second-category nodes, and reduce the time required for the operation. For example, the processor 144 may quickly find the signal transmission path of each of the at least one first-category node to each of the at least one second-category node through a query language (i.e., Graph SQL) provided by the graph database 156 (e.g., according to the adopted selection strategy, finding out the lowest energy consumption, the minimum communication delay, or/and the longest connection lifetime of the signal transmission path by the query language), and calculates the evaluation cost of the signal transmission path, wherein the evaluation cost is the failover cost.

In some embodiments, the processor 144 of the device for failover 140 converts each device metadata 122 transmitted by the plurality of first-category devices 102 into a hash tree, and then stores each hash tree in a format conforming to the graph database 156. Each hash tree comprises a plurality of leaf nodes, a plurality of parent nodes, and a root node, wherein the plurality of leaf nodes, the plurality of parent nodes, and the root node correspond to the same time interval (e.g., the same day). For any hash tree, each leaf node comprises a leaf data and a corresponding leaf hash thereof, and each leaf data is one of the backup data generated in a certain time period (e.g., 00:00-07:59, 08:00-15:59, and 16:00-23:59) of the time interval, each leaf hash is obtained by calculating a corresponding leaf data through the hash function. For any hash tree, each parent node contains a parent hash, and each parent hash is obtained by calculating a leaf hash of the same time interval and the same time period through the hash function. For any hash tree, the root node comprises at least one root hashes in the same time interval but in different time periods, and each root hash is obtained by calculating at least one corresponding parent hash through the hash function.

In some embodiments, the processor 144 of the device for failover 140 finds out verified at least one leaf data according to the hash function and the plurality of hash data of the at least one hash trees corresponding to the first device, and the processor 144 converts the verified at least one leaf data to a recovery data, wherein each of the recovery data conforms to a metadata format of the IOT system 100. Each of the recovery data is the data which is obtained by converting the backup data, which is previously transmitted from the first device to the device for failover 140, into a data conforming to the format of management metadata 152, and then further converting them to a data conforming to the format of the IoT system 100. Then, the network interface 142 transmits the recovery data to the second device, so that the second device obtains the system setting of the first device from the recovery data to replace the first device, and continues to provide the service and function originally provided by the first device.

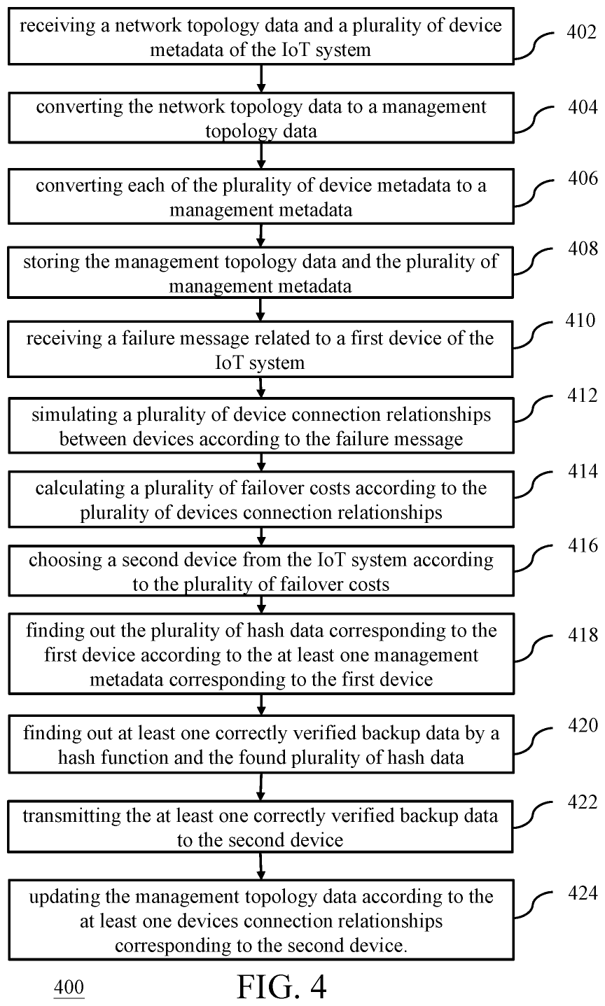

A second embodiment of the present invention is a method for failover, and a flow chart thereof is illustrated in FIG. 4. The method for failover 400 is applicable to an electronic computing device (e.g., the device for failover 140) of an IoT system (e.g., the aforementioned IoT system 100). The method for failover 400 comprises steps 402 to 424, as detailed below.

In step 402, the electronic computing device receives a network topology data 124 and a plurality of device metadata 122 of the IoT system 100, wherein each device metadata 122 comprises a plurality of backup data and a plurality of hash data. It should be noted that the present invention does not limit the device metadata 122 to be received together. In other words, whenever a first-category device 102 transmits a device metadata 122, the method for failover receives the device metadata. In step 404, the network topology data 124 is converted by the electronic computing device to a management topology data 154. In step 406, each device metadata 122 is converted by the electronic computing device into a management metadata 152. In step 408, the management topology data 154 and the management metadata 152 are stored by the electronic computing device. By performing steps 402 to 408, the electronic computing device continuously backs up the important information comprised in the first-category device 102 of the IoT system 100.

In the present embodiment, each of the management topology data 154 and the management metadata 152 conforms to a format of a graph database 156, wherein each of the management topology data 154 and the management metadata 152 comprises a plurality of node data, a plurality of edge data, a plurality of node property data, and a plurality of edge property data. It should be noted that, in some embodiments, the management topology data 154 and the management metadata 152 do not have to conform to the format of the graph database 156.

In step 410, the electronic computing device receives the failure message of the IoT system 100 about a first device, wherein the failure message comprises the identification information of the first device. In step 412, the electronic computing device simulates a plurality of device connection relationships according to the failure message, and the simulated device connection relationships may be regarded as a potentially configurable connection relationship as a basis for analysis by the method for failover temporarily. In step 414, the electronic computing device calculates a plurality of failover costs based on the device connection relationships, wherein each of the plurality of failover costs relates to one of or a combination of: an energy consumption, a communication delay, and a connection lifetime. In step 416, the electronic computing device selects a second device to replace the failed first device from the IoT system 100 according to the failover costs. By performing steps 410 to 416, the method for failover analyzes the actual connection status and the potentially configurable connection relationships of the IoT system 100, and then dynamically finds out the expecting device for replacement and the alternative signal transmission path. In this embodiment, before performing step 412, the method for failover may perform another step of finding, by the electronic computing device, the node data, the at least one edge data, and the plurality of node property data of the management topology data 154 corresponding to the failure message, and performing another step of removing, by the electronic computing device, the at least one edge data and the plurality of node property data corresponding to the failure message and then simulating the plurality of device connection relationships, and then performing step 412.

In some embodiments, step 414 comprises a first step of obtaining, by the electronic computing device, at least one first-category nodes which have a work association with the first device according to the management topology data 154. Step 414 also comprises a second step of obtaining, by the electronic computing device, at least one second-category nodes which may be objects for failover according to the management topology data 154. Step 414 further comprises a third step of calculating, by the electronic computing device, an evaluation cost of transmitting from each of the at least one first-category nodes to each of the at least one second-category nodes as the plurality of failover costs according to the plurality of edge data and the plurality of edge property data of the management topology data 154. The aforesaid first-category node may be a sensor, and the second-category of node, the first device, and the second device may all be gateways.

Step 418 is performed after step 416, in which the electronic computing device finds out the hash data corresponding to the first device according to the at least one management metadata 152 corresponding to the first device. In step 420, the electronic computing device finds out at least one correctly verified backup data by a hash function and the found plurality of hash data. The hash function is one of a Secure Hash Algorithm 1 (SHA-1) and an MD5 Message-Digest Algorithm. At step 422, the electronic computing device transmits the at least one correctly verified backup data to the second device. In step 424, the electronic computing device updates the management topology data according to the at least one device connection relationships corresponding to the second device. By performing step 418 to step 424, the one from which is failover verifies the validity of the backup data received from the IoT system 100, and transmits only the verified backup data to the succeed device to continue providing the services and features previously provided by the failed device by the succeed device.

In some embodiments, each of the plurality of management metadata is a hash tree, and each of the hash trees comprises a plurality of leaf nodes, a plurality of parent nodes, and a root node. Further, each of the plurality of leaf nodes comprises a leaf data and a leaf hash, each of the leaf hash is one of the at least one backup data, each of the leaf hash is obtained by calculating the corresponding leaf data via the hash function, each of the parent nodes comprises a parent hash, each of the parent hash is obtained by calculating the corresponding leaf hash via the hash function, each of the root nodes comprises at least one root hash, and each of the root hash is obtained by calculating the at least one corresponding parent hash via the hash function. In these embodiments, step 420 performs a step of finding out, by the electronic computing device, verified at least one leaf data according to the hash function and the plurality of hash data of the at least one hash trees corresponding to the first device, and performs the other step of converting, by the electronic computing device, the verified at least one leaf data to a recovery data, wherein each of the recovery data conforms to a metadata format of the IoT system.

In addition to the above steps, the second embodiment may also perform all the operations and steps described in the first embodiment, have the same functions, and achieve the same effect. A person having ordinary skill in the art may directly understand how the second embodiment performs the operations and steps based on the first embodiment described above, has the same functions, and achieves the same technical effects, and thus will not be described again.

In summary, the device and method for failover provided by the present invention may calculate a plurality of failover costs according to a real-time device connection relationship of the IoT system when a device of the IoT system fails, and select an object for failover and the signal transmission path for handover on-the-fly according to the failover costs. In this way, the device and method for failover provided by the present invention improve the fault tolerance of the IoT system with a single device, save additional costs for configuration of dedicated backup devices, and exert the good extensibility and flexibility of the IoT system. In addition, the device and method for failover provided by the present invention verify the integrity of the backup data through multiple layers of hash values. Thereby, the device and method for failover provided by the present invention avoid transmitting incomplete or erroneous data to the object of failover which leads to partial IoT system shutdown and, therefore, increasing the stability of the system. Furthermore, since the device and method for failover provided by the present invention may adjust the calculation method of the failover cost according to different considerations, the flexible of use is further increased.

The device and method for failover of the present invention may fully utilize the network connection advantages of the IoT system, and solve the dilemma that the prior art cannot both expand of the number of devices in the IoT system and improve the fault tolerance of the IoT system.

The above disclosure is only intended to illustrate some of the embodiments of the present invention, and the detailed technical and technical features of the present invention are not intended to limit the scope of protection and scope of the present invention. Any arrangements that can be retouched, replaced, altered, and equally arranged by a person having ordinary skill in the art based on the above disclosures and suggestions are within the scope of the present invention, and the scope of protection of the invention is defined by the following Claims.

What is claimed is:

1. A device for failover, comprising:
a network interface, being connected to an Internet of Things (IoT) system, and being configured to receive a network topology data and a plurality of device metadata of the IoT system, each of the plurality of device metadata comprising a plurality of backup data and a plurality of hash data;
a processor, being connected to the network interface, and being configured to convert the network topology data to a management topology data and convert each of the plurality of device metadata to a management metadata; and
a storage, being connected to the processor, and configured to store the management topology data and the plurality of management metadata;
wherein the network interface receives a failure message related to a first device of the IoT system, the processor simulates a plurality of device connection relationships according to the failure message, calculates a plurality of failover costs according to the plurality of device connection relationships, and chooses a second device from the IoT system according to the plurality of failover costs, the processor finds out the plurality of hash data corresponding to the first device according to the at least one management metadata corresponding to the first device, and finds out at least one correctly verified backup data by a hash function and the found plurality of hash data, the network interface transmits the at least one correctly verified backup data to the second device, and the processor updates the management topology data according to the at least one device connection relationships corresponding to the second device.

2. The device for failover of claim 1, wherein each of the plurality of failover costs relates to one of or a combination of: an energy consumption, a communication delay, and a connection lifetime.

3. The device for failover of claim 1, wherein the management topology data and the at least one management metadata conform to a format of a graph database, and each of the management topology data and the at least one management metadata comprises a plurality of node data, a plurality of edge data, a plurality of node property data, and a plurality of edge property data.

4. The device for failover of claim 3, wherein the processor further finds out the node data, the at least one edge data, and the plurality of node property data of the management topology data corresponding to the failure message, removes the at least one edge data and the plurality of node property data corresponding to the failure message, and then simulates the plurality of device connection relationships.

5. The device for failover of claim 3, wherein the processor further obtains at least one first-category nodes which have a work association with the first device according to the management topology data, obtains at least one second-category nodes which may be objects for failover according to the management topology data, and calculates an evaluation cost of data transmission from each of the at least one first-category nodes to each of the at least one second-category nodes as the plurality of failover costs according to the plurality of edge data and the plurality of edge property data of the management topology data.

6. The device for failover of claim 5, wherein each of the at least one first-category nodes is a sensor, and each of the at least one second-category nodes, the first device, and the second device is a gateway.

7. The device for failover of claim 1, wherein each of the plurality of management metadata is a hash tree, and each of the hash trees comprises a plurality of leaf nodes, a plurality of parent nodes, and a root node.

8. The device for failover of claim 7, wherein each of the plurality of leaf nodes comprises a leaf data and a leaf hash, each of the leaf data is one of the at least one backup data, each of the leaf hash is obtained by calculating the corresponding leaf data via the hash function, each of the parent nodes comprises a parent hash, each of the parent hash is obtained by calculating the corresponding leaf hash via the hash function, each of the root nodes comprises at least one root hash, and each of the root hash is obtained by calculating the at least one corresponding parent hash via the hash function.

9. The device for failover of claim 7, wherein the processor finds out at least one correctly verified leaf data according to the hash function and the plurality of hash data of the at least one hash trees corresponding to the first device, and the processor converts the at least one correctly verified leaf data to a recovery data, each of the recovery data conforms to a metadata format of the IoT system.

10. The device for failover of claim 1, wherein the hash function is one of a Secure Hash Algorithm 1 (SHA-1) and an MD5 Message-Digest Algorithm.

11. A method for failover, the method being suitable for an electronic computing device of an IoT system, the method comprising:
(a) receiving a network topology data and a plurality of device metadata of the IoT system, wherein each of the plurality of device metadata comprises a plurality of backup data and a plurality of hash data;
(b) converting the network topology data to a management topology data;
(c) converting each of the plurality of device metadata to a management metadata;
(d) storing the management topology data and the plurality of management metadata;
(e) receiving a failure message related to a first device of the IoT system;
(f) simulating a plurality of device connection relationships according to the failure message;
(g) calculating a plurality of failover costs according to the plurality of device connection relationships;
(h) choosing a second device from the IoT system according to the plurality of failover costs;
(i) finding out the plurality of hash data corresponding to the first device according to the at least one management metadata corresponding to the first device;
(j) finding out at least one correctly verified backup data by a hash function and the found plurality of hash data;
(k) transmitting the at least one correctly verified backup data to the second device; and
(l) updating the management topology data according to the at least one device connection relationships corresponding to the second device.

12. The method for failover of claim 11, wherein each of the plurality of failover costs relates to one of or a combination of: an energy consumption, a communication delay, and a connection lifetime.

13. The method for failover of claim 11, wherein the management topology data and the at least one management metadata conform to a format of a graph database, and each of the management topology data and the at least one management metadata comprises a plurality of node data, a plurality of edge data, a plurality of node property data, and a plurality of edge property data.

14. The method for failover of claim 13, further comprising:
finding out the node data, the at least one edge data, and the plurality of node property data of the management topology data corresponding to the failure message; and
removing the at least one edge data and the plurality of node property data corresponding to the failure message;
wherein the step (f) is performed after the step of removing.

15. The method for failover of claim 13, wherein the step (g) comprises:
obtaining at least one first-category nodes which have a work association with the first device according to the management topology data;
obtaining at least one second-category nodes which may be objects for failover according to the management topology data; and
calculating an evaluation cost of data transmission from each of the at least one first-category nodes to each of the at least one second-category nodes as the plurality of failover costs according to the plurality of edge data and the plurality of edge property data of the management topology data.

16. The method for failover of claim 15, wherein each of the at least one first-category nodes is a sensor, and each of the at least one second-category nodes, the first device, and the second device is a gateway.

17. The method for failover of claim 13, wherein each of the plurality of management metadata is a hash tree, and each of the hash trees comprises a plurality of leaf nodes, a plurality of parent nodes, and a root node.

18. The method for failover of claim 17, wherein each of the plurality of leaf nodes comprises a leaf data and a leaf hash, each of the leaf data is one of the at least one backup data, each of the leaf hash is obtained by calculating the corresponding leaf data via the hash function, each of the parent nodes comprises a parent hash, each of the parent hash is obtained by calculating the corresponding leaf hash via the hash function, each of the root nodes comprises at least one root hash, and each of the root hash is obtained by calculating the at least one corresponding parent hash via the hash function.

19. The method for failover of claim 17, wherein the step (j) comprises:
finding out at least one correctly verified leaf data according to the hash function and the plurality of hash data of the at least one hash trees corresponding to the first device; and
converting the at least one correctly verified leaf data to a recovery data, each of the recovery data conforms to a metadata format of the IoT system.

20. The method for failover of claim 11, wherein the hash function is one of a Secure Hash Algorithm 1 (SHA-1) and an MD5 Message-Digest Algorithm.
